(19) United States
(12) Patent Application Publication
(10) Pub. No.: US 2018/0361188 A1
(43) Pub. Date: Dec. 20, 2018

(54) Modular Amusement Play Structure Employing Multi-Piece Connectors

(71) Applicant: Pucuda, Inc., Madison, CT (US)

(72) Inventors: John Rexroad, Killingworth, CT (US); Randolph J. Danowski, Guilford, CT (US)

(73) Assignee: Pucuda, Inc., Madison, CT (US)

(21) Appl. No.: 15/230,151

(22) Filed: Aug. 5, 2016

(51) Int. Cl. A63B 17/04; A63G 21/02; A63G 31/00; F16B 7/18

(52) U.S. Cl. CPC A63B 17/04; F16B 7/185; A63G 31/00; A63G 21/02

(57) ABSTRACT

In various representative aspects, a modular play structure is created using multi-piece connectors and rod members and their connecting elements. The multi-piece connector for facilitating the construction of a modular amusement play structure herein includes a first piece defining a tubular connection member having a first end, the first end adapted for abutting connection, a second piece defining a tubular connection member having a first end, the first end adapted for abutting connection with the first piece and an inner connection member sized and shaped to fit within the first and second pieces. The inner connection member being expandable and including releasable locking members interconnecting with the inner connection member adapted for expanding the inner connection member and reversing the same.

### BACKGROUND OF INVENTION

The present invention relates generally to providing a modular amusement play structure using multi-piece connectors. More specifically, the invention relates to providing multi-piece connectors and rods for the construction of a safe modular amusement play structure, which is readily assembled, disassembled, and reconfigured for different challenges.

In the construction of a play structure according to the disclosure herein, children are the primary users of the structure. Children of this age tend to have small hands and feet as well as thin arms and legs. Therefore, fully assembled such play structures should minimize areas where extremities and limbs of such young persons could be injured.

In a typical play structure, construction includes the use of cables to secure the netting to the play structure and more particularly to the structural steel frame members. It is a natural quality of cables to provide “give” in any construction situation. This “give” results in flexion both laterally and vertically from the steel frame members used as the primary support in such assemblies. As the cables give way from the steel frame structures, gaps are created between the netting and the structural supports as shown in the figures hereto. Additionally, unexpected and somewhat unpredictable uneven terrain is created by the citing of the netting as a result of the give of the cables.

Other prior art approaches have included the use of welded stanchions. The stanchions are welded to the structural steel members through arms 562 as described below with respect to FIG. 24. It will be readily appreciated that such a construction apparently creates the type of gaps sought to be avoided during use of the amusement structures for children and young adults.

The construction of such play structures can be quite painstaking and tedious using cables and welded stanchions of the type known in the prior art. Depending on the complexity of the play structure, the construction can take weeks, if not months to complete. Each critical area must be examined to minimize gaps and to insure safe construction.

What is needed is a safe and reliable play structure to insure the minimum risk for children and young adults for injury. What is also needed is a construction structure which allows for efficient construction of an amusement play structure as well as the ability to change a portion of the play structure as desired. Thus the play structure should include an ability to easily modify the construction without having to disassemble the entire structure and then reassembled that portion desired.

### SUMMARY OF THE INVENTION

The invention is summarized below only for purposes of introducing embodiments of the invention. The ultimate scope of the invention is to be limited only to the claims that follow the specification.

It is an object of this invention to provide a multi-piece connector which facilitates the construction of an amusement play structure in accordance with this disclosure.

It is an additional object of this invention to provide a multi-piece connector which facilitates the assembly and disassembly of only a portion of the amusement play structure, therefore defining the amusement play structure as a module play structure.

It is an additional object of this invention to provide a multi-connector which facilitates the use of law that members to replace cables in the construction of a module or amusement play structure.

An embodiment of this invention comprises a multi-piece connector for facilitating the construction of a modular amusement play structure. The multi-piece connector includes a first piece defining a tubular connection member having a first end. The first end shaped for abutting connection. A second piece defining a tubular connection member having a first end. The first end shaped for abutting connection with the first piece. And an inner connection member sized and shaped to fit within the first and second pieces, the inner connection member being expandable and including releasable locking members interconnecting with the inner connection ember adapted for expanding the inner connection member and reversing the same as desired.

In another exemplary embodiment, the multi-piece connector for facilitating the construction of a modular amusement play structure includes a first piece defining a tubular connection member having a first end. The first end shaped for abutting connection. A second piece defining a tubular connection member having a first end. The first end shaped for abutting connection with the first piece. And an inner connection member sized and shaped to fit within the first and second pieces, the inner connection member being expandable and including releasable locking members interconnecting with the inner connection ember adapted for expanding the inner connection member and reversing the same as desired. And, additionally includes a third piece defining a tubular rod connection member. The rod connection member positioned in use over the inner connection member and between the first and second connection members. The rod connection member being freely rotating between the first and second connection member until the locking members expand the inner connection member.

It will be appreciated that when the first and second pieces are brought into abutting connection with the rod connection member, the rod connection member remains freely rotating. This free rotation continues until the locking members engage and expand the inner connection member for locking the first, second and third pieces together. At that time all the pieces are in locked relation to one another.

In an exemplary embodiment, the rod connection member includes and outwardly extending flange. The flange has one or more apertures adapted to accept one or more of the rod members. Additional apertures are desired in the exemplary embodiments to facilitate the ease of construction of the modular play structure. Additional exemplary embodiments include the rod connecting member having more than one flange.

In another exemplary embodiment, a rod member is included. In this embodiment, the invention comprises, a multi-piece connector for facilitating the construction of a modular amusement play structure, the multi-piece connector includes a first piece defining a tubular connection member having a first end. The first end is adapted for abutting connection. The multi-piece connector includes a second piece defining a tubular connection member. The second piece has a first end and the first end is adapted for abutting connection with the first piece. The multi-piece connector includes an inner connection member sized and shaped to fit within the first and second pieces, the inner connection member being expandable and including releasable locking members interconnecting with the inner connection member and adapted for expanding the inner connection member and reversing the same as desired. The multi-piece connector includes a third piece defining a tubular rod connection member. The rod connection member positioned over the inner connection member and between the first and second connection members and being freely rotating between the first and second connection members until the locking members expand the inner connection member. And, the multi-piece connector includes at least one rod member adapted for connection to the tubular rod connection member.

As will be appreciated, when the first and second pieces are brought into abutting connection with the rod connection member, the rod connection member remains freely rotating until the locking members engage and expand the inner connection member. This facilitates the ease of connecting the rod member to the rod connecting member since generally some small adjustments are required during construction as well as disassembly.

A person with ordinary skill in the relevant art would know that any shape or size of the connector or the rod may be adopted as long as the assembly can be used to create a modular play structure. Any combinations of suitable elements of those described above and of those which will be more fully appreciated hereinafter regardless of the shape and size of the particular elements are within the spirit and scope of the disclosure herein. Also, any materials suitable to achieve the object of the current invention may be chosen, within the spirit and scope of this disclosure.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1A illustrates a perspective view of a modular amusement play structure employing the connectors and rods of the disclosure herein.

FIG. 1B illustrates a front view of the modular amusement play structure of FIG. 1A showing particularly, tower assemblies and multi-level floor structures and atrium spaces.

FIG. 1C illustrates an exploded perspective view of a multi-piece connector in accordance with this disclosure.

FIG. 2 illustrates a perspective view of a fully assembled multi-piece connector in accordance with this disclosure.

FIG. 3 illustrates a front exploded view of a multi-piece connector in accordance with this disclosure having a freely rotating connection member.

FIG. 4 illustrates a cross sectional view of the inner connection member.

FIGS. 5 & 6 illustrate front views of prior art connections for a frame for an amusement device.

FIG. 7 illustrates an enlarged view of the inner member in cross sectional view.

FIGS. 8 & 9 illustrate, in cross sectional view, the locking portion of the inner connection member in the unlocked and locked positions.

FIGS. 10, 11 & 12 illustrate front views of different exemplary embodiments of the rod connection member.

FIG. 13 illustrates a front exploded view of the connector in accordance with the instant disclosure.

FIG. 14 illustrates a perspective view of a subassembly of the modular play structure with rods connecting a floor portion.

FIG. 15 illustrates an enlarged view of the subassembly of FIG. 14.

FIGS. 16-18 illustrate front views of the rod connection member in relation to the other members of the multi-piece connector in accordance with this disclosure.

FIG. 19 illustrates a perspective view of an exemplary embodiment of a rod member showing its connecting ends.

FIG. 20 illustrates a close up front view of the connecting ends of the rod member.

FIGS. 21 & 22 illustrates front views of the connection of the rod member to the netting.

FIG. 23 illustrates a front view of a prior art cable connection to the netting.

FIG. 24 illustrates a front view of a prior art welded cable connection to the netting.

FIG. 25 illustrates a fully front view of a constructed portion of the modular assembly under load using the rod members in accordance with the disclosure herein.

FIG. 26 illustrates a perspective view of a prior art construction of a play structure employing cables and steel structural supports.

### DETAILED DESCRIPTION OF EXEMPLARY EMBODIMENTS

In the following description, and for the purposes of explanation, numerous specific details are provided to thoroughly understand the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed embodiments may be applied. The full scope of the inventions is not limited to the examples that are described below.

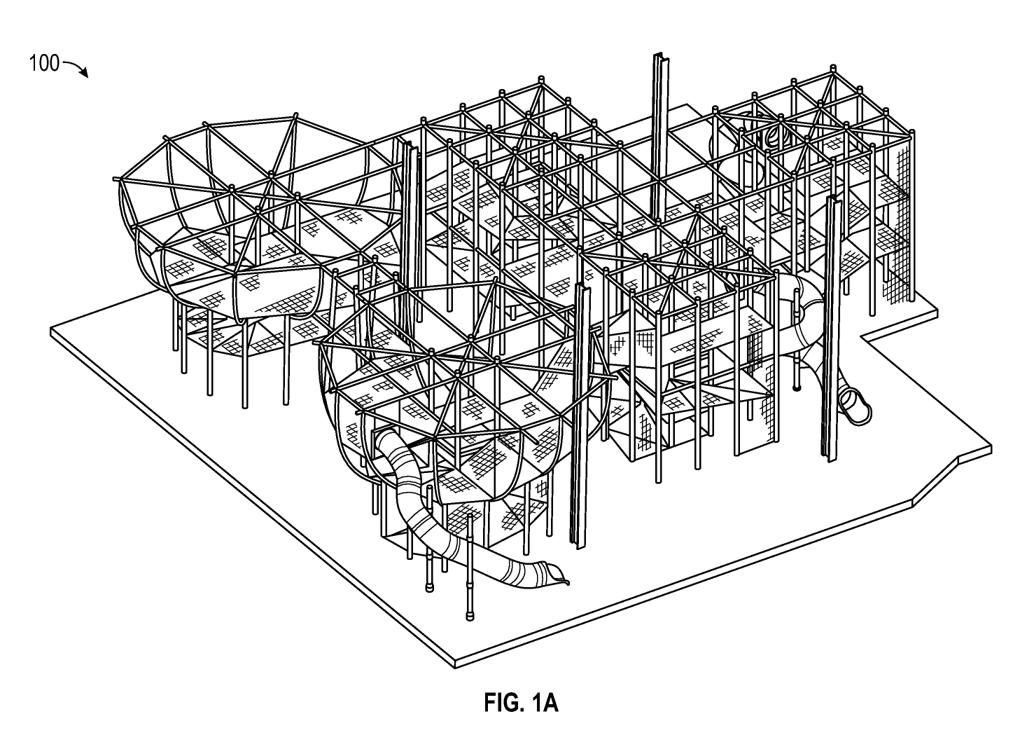

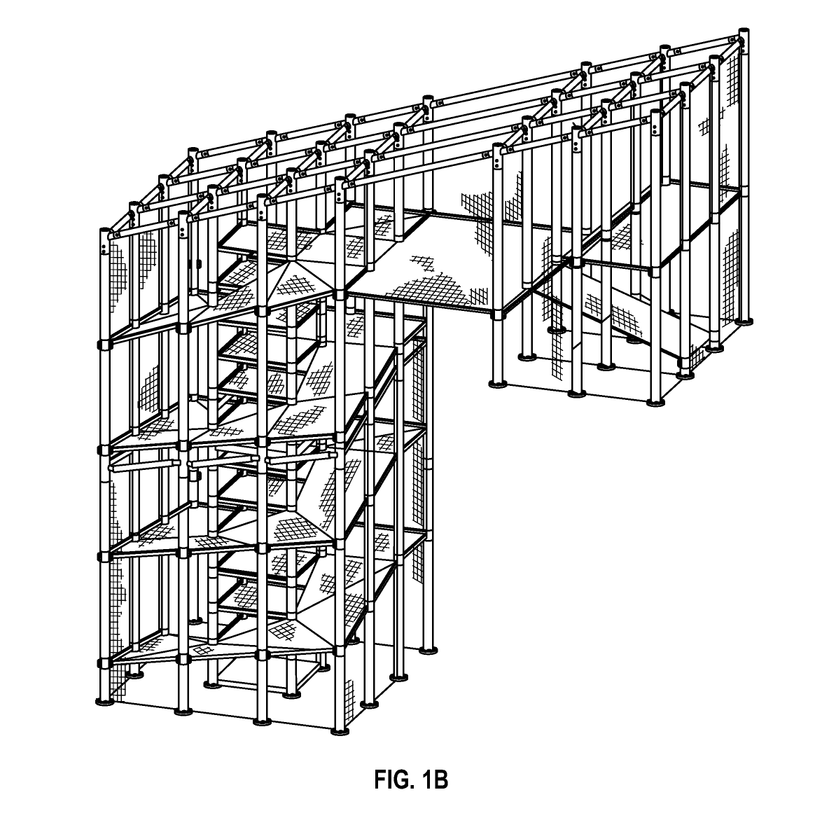

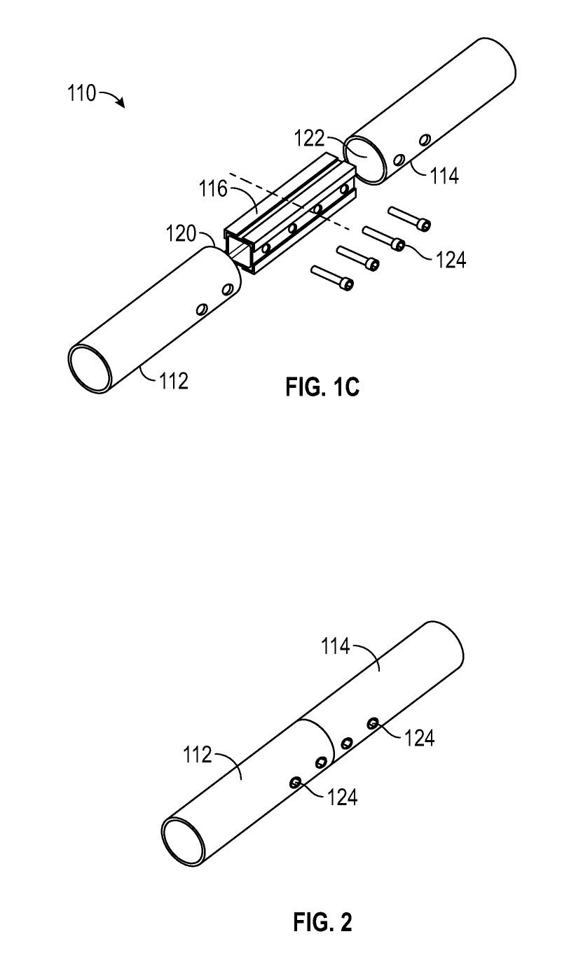

FIG. 1A illustrates a modular amusement play structure generally indicated by the numeral 100. The modular amusement play structure 100 is constructed using a plurality of connectors and rod members in accordance with the disclosure herein. The modular amusement play structure 100 includes Tree Towers 1 & 2 and Towers 1, 2 & 3. FIG. 1B illustrates the detail flooring and rod members and connectors of Tower 1 of FIG. 1A.

FIGS. 1C & 2 illustrate the multi-piece connector 110 used to facilitate creating the modular play structure of FIGS. 1A & 1B. The multi-piece connector includes a first piece 112, a second piece 114 and an expandable inner connection member 116. Locking members 124 in the form of bolts are provided in the illustrated exemplary embodiment for expanding the inner connection member 116 and providing a secure locking connection.

The first piece 112 defines a tubular connection member having a first end 120. The first end 120 is sized and shaped for abutting connection with the second piece 114. The second piece 114 defining a tubular connection member having a first end 122. The first end 122 sized and shaped for abutting connection with the other first end 120. The inner connection member 116 is sized and shaped to fit within the first and second pieces, 112 and 114, respectively. As will be appreciated from the description below, the inner connection member 116 is expandable. The inner connection member 116 includes releasable locking members 124. In the exemplary embodiment shown in FIG. 1 and FIG. 2, the releasable locking members 124 define bolts. As will be appreciated from the more detailed description below, the bolts are turned so as to expand the inner connection member 116 for locking the first and second pieces, 112 and 114, respectively together. The bolts are used to shrink the inner connection member 116 in order to disassemble the module play structure 100.

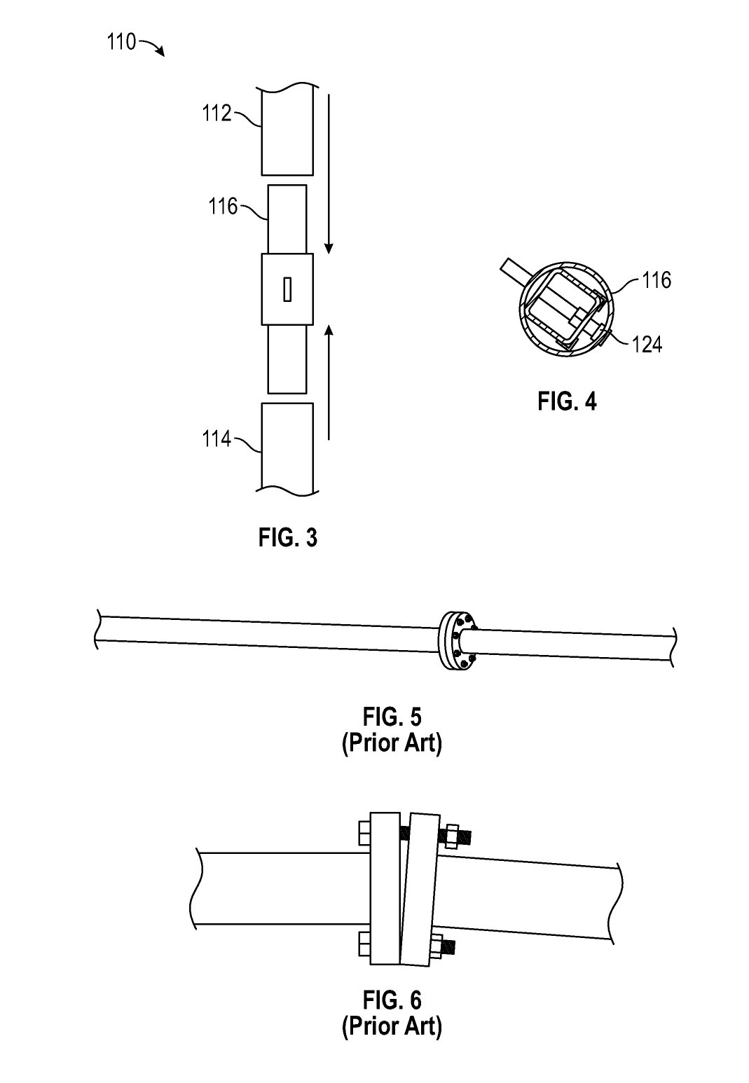

With respect to FIG. 3, there is shown the exploded structure of the multi-piece connection member 110. As shown, the first piece 112 slides over the inner connection member 116 in the direction of the arrow. Similarly, the second piece 114 is slid over the inner connection 116, but in the opposite direction until the ends 120 and 122 are abutting. Once the ends 120 and 122 are abutting, the locking members 124 are available for locking the first and second pieces, 112 and 114 together by expanding the inner connection member 116.

With particular reference to FIG. 4, there is shown a cross-sectional view of the inner connection member 116. As shown, the locking member 124 has expanded the inner connection member 116 to create a locking connection between the first and 2^{nd} pieces, 112 and 114, respectively.

FIGS. 5 and 6 illustrate the type of connection used to connect the pipe members in the prior art. As seen particularly in FIG. 5, a substantial flange exists in the connection. The flange is sufficiently extending from the connection such that the play structure participants can catch their clothes, fingers or hands on the extending structure. Additionally, as best illustrated in FIG. 6, a load force brought to bear on one of the pipes can cause an unwanted aberrational structure, where one pipe begins to separate at the joint from another. Clearly, this aberrational structure is not desired and provides a weakening of the modular play structure as well as an avenue for clothing or little feet to be caught and possibly injure participants.

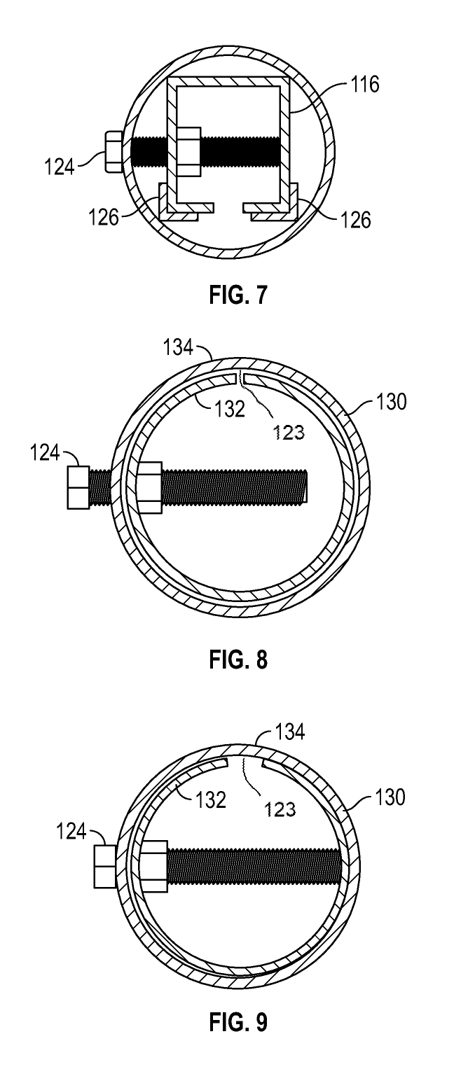

With particular reference to FIG. 7, an enlarged view is shown of the inner connection member 116 in its expanded or locked state locking the first and second pieces 112 and 114, respectively together. As shown, by turning the locking members 124 the inner connection member 116 expands or contracts. In order to secure the first and second pieces together, 112 and 114, respectively, the bolts, comprising the locking members 124, are rotated to expand the inner connection member 116. As shown in cross-section, the inner connection member 116 in an exemplary embodiment, is provided with shoulder pads 126 to facilitate secure connection with the first and second pieces, 112 and 114, respectively

FIGS. 8 and 9 illustrate another embodiment of inner connection member 130. In this exemplary embodiment, the inner connection member 130 includes inner and outer rings, 132 and 134, respectively. As the locking members 124 are rotated, the inner lane 132 urges the outer ring 134 to expand. And, when the locking members 124 are rotated in the opposite direction, the inner ring 132 contracts, allowing the outer ring 130 to return to its normal unexpanded position.

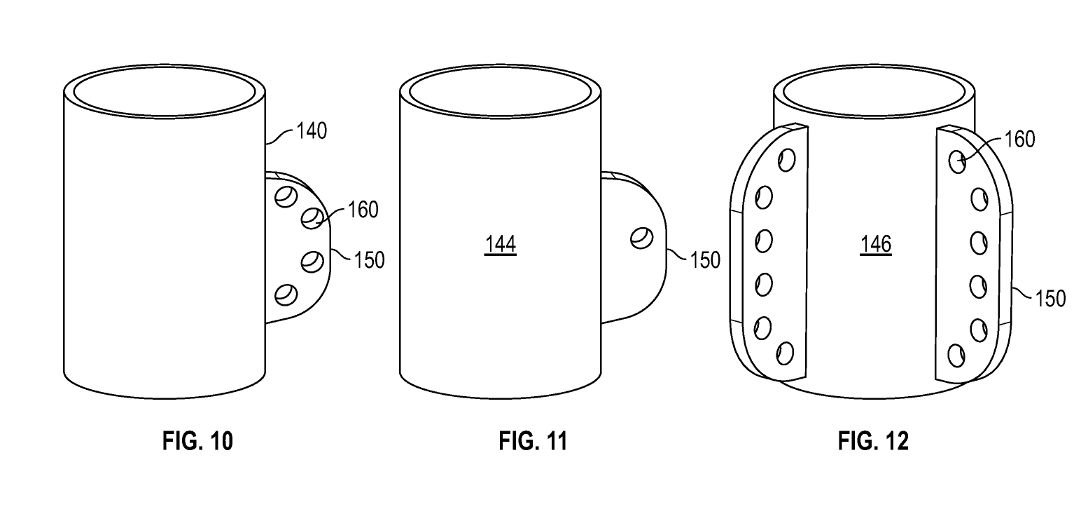

With respect to FIGS. 10, 11 and 12, there is shown an additional exemplary embodiment of the multi-piece connector 100, which includes tubular rod connection members 140-148. It will be appreciated that an infinite number of embodiments of the tubular rod connection member are possible, each of which, based upon this disclosure, are within the spirit and scope of the invention herein. As will be appreciated by viewing the figures mentioned above, the rod connection members each include a flange defining at least one ear extending from the surface of the tubular rod connection member. For example, FIG. 10 shows a single ear 150 extending from the surface of the tubular rod connection member 140.

On the other hand, the embodiments illustrated in FIG. 12 show multi-ear embodiments. Each of the tubular blog members 146 and 148, respectively include two ears extending from the surface of each connector. In the embodiment 146, the ears 150 are staggered. In the embodiment 148, the ears are opposed. The other embodiments, 142 and 144, respectively in FIGS. 10 and 11 illustrate the remaining single ear embodiments.

Each ear 150 includes one or more apertures 160. The apertures 160 are sized and shaped and adapted for connection with the rod members. As will be appreciated from the detailed discussion below, the additional apertures 160 allow the rod members to connect at different angles and thereby facilitate the ease of construction of the play structure 100.

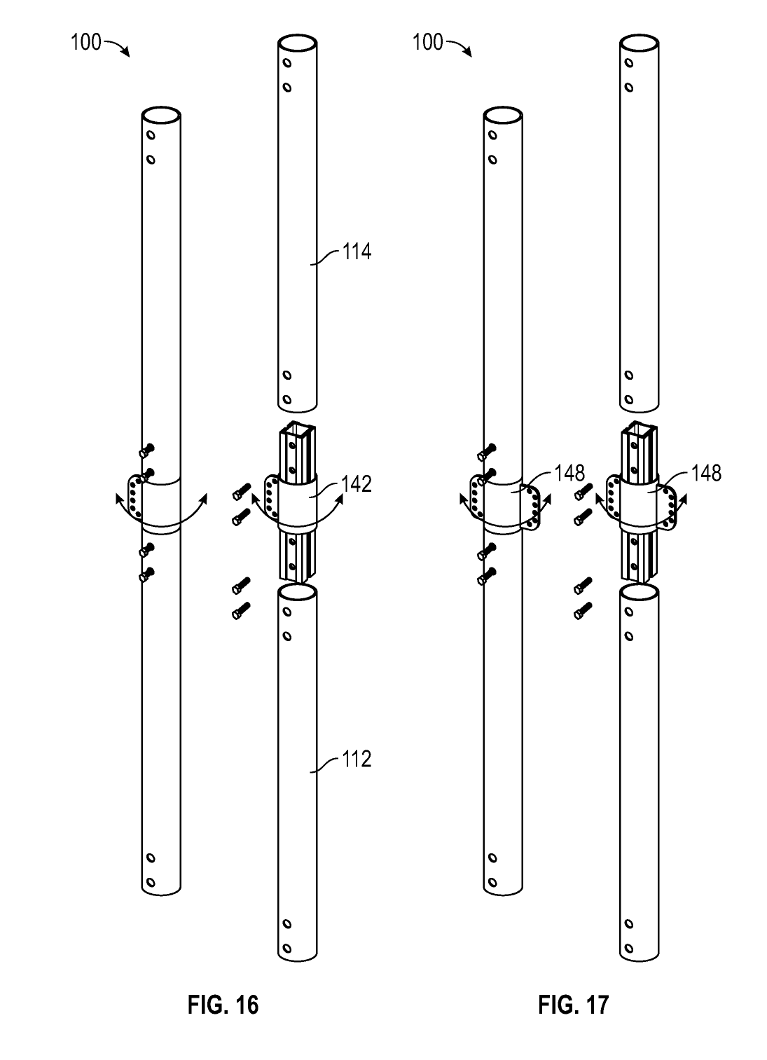

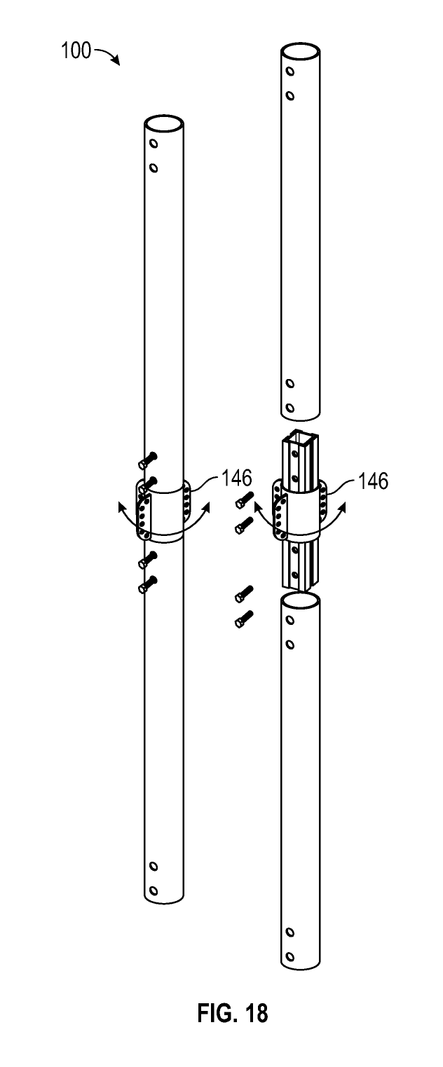

With particular reference to FIGS. 16, 17 and 18, there is shown tubular rod connection members 142, 146 & 148. With particular respect to FIG. 16, there is shown the multi-piece connector 110 having tubular rod connection member 142 in the assembled and disassembled states. With particular reference to FIG. 17, there is shown the multi-piece connector 110 having tubular rod connection member 148 in the assembled and disassembled states. With particular reference to FIG. 18, there is shown the multi-piece connector 110 having tubular rod connection member 146 in the assembled and disassembled states.

By providing the multi-piece connector 100 in accordance with this disclosure assembly and disassembly is readily accomplished. New towers, floors, tower trees can be readily assembled or disassembled to suit the purpose intended. The look and feel of the play structure can thus readily be changed to provide new challenges and amusements for young participants.

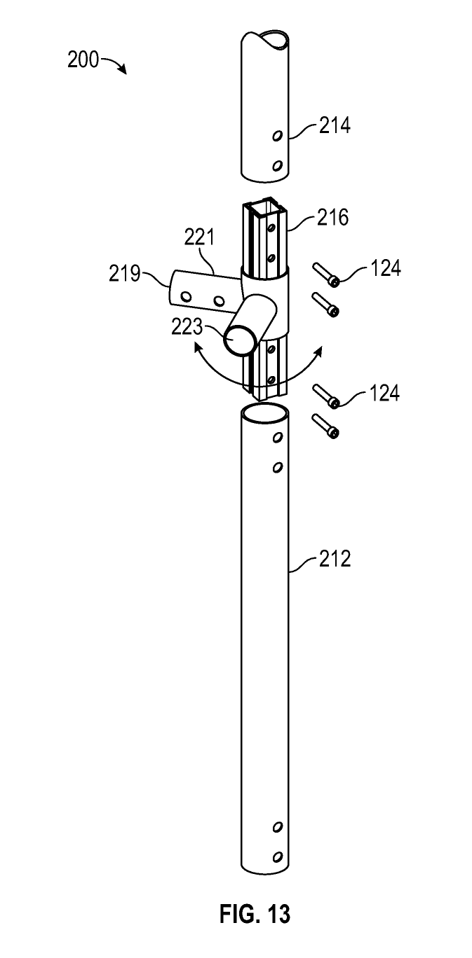

With respect to FIG. 13, there is shown another exemplary embodiment of the multi-piece connector in accordance with this disclosure, generally indicated by the numeral 200. The multi-piece connector 200 includes a first piece 212, a second piece 214, an expandable inner connection member 216, and a freely rotating center member 219. The first piece and second piece, 212 and 214 respectively are aligned for abutting connection. Each of the pieces, 212 and 214 respectively fit over the inner connection member 216. The center member 219 is slid over the inner connection member 216 between the first and second pieces, 212 and 214 respectively. The center member 219 freely rotates around the inner connection member 216 until the inner connection member 216 is expanded. Once the inner connection member 216 is expanded rotation of the center member 219 is no longer possible. As will be appreciated from the detailed discussion below, the ability of the center member 219 to rotate greatly facilitates the connection of the rod members to the multi-piece connector 200.

As illustrated, the inner connection member 216 extends beyond the center member 219. The first and second pieces, 212 and 214 respectively are slid over the inner connection member 216 so that all of the elements are effectively in abutting and aligned relationship. Locking members 124 are then applied to the first and second pieces 212 and 214 respectively. The locking members 124 are rotated to expand or contract the inner connection member 216, as desired.

The center member 219 includes connection ends 221 and 223. As illustrated the ends 221 and 223 are adapted for connection with an inner connection member to facilitate the assembly of the modular play structure 100.

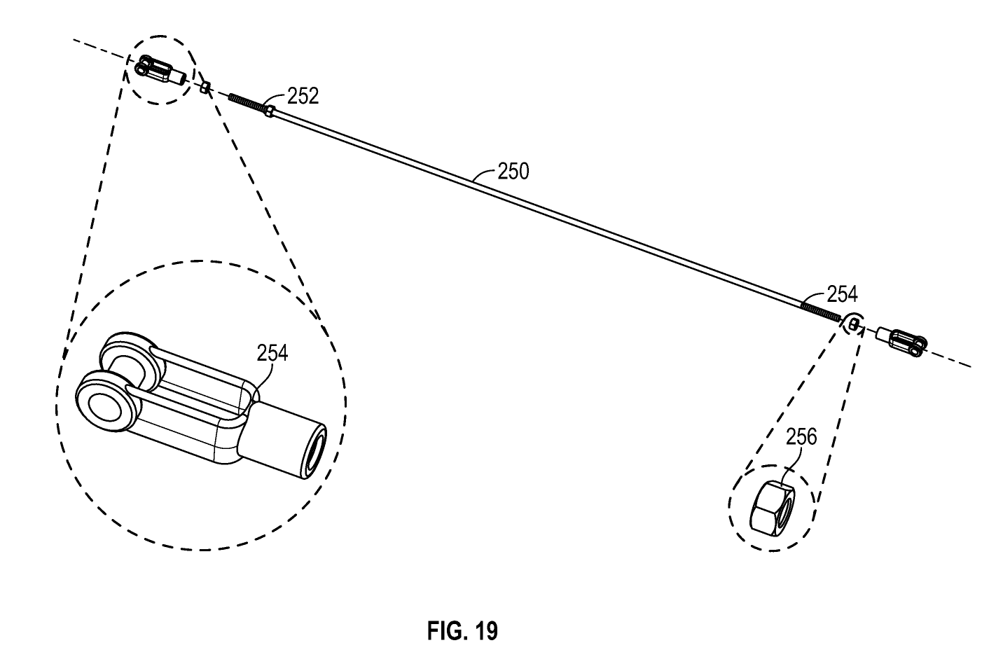

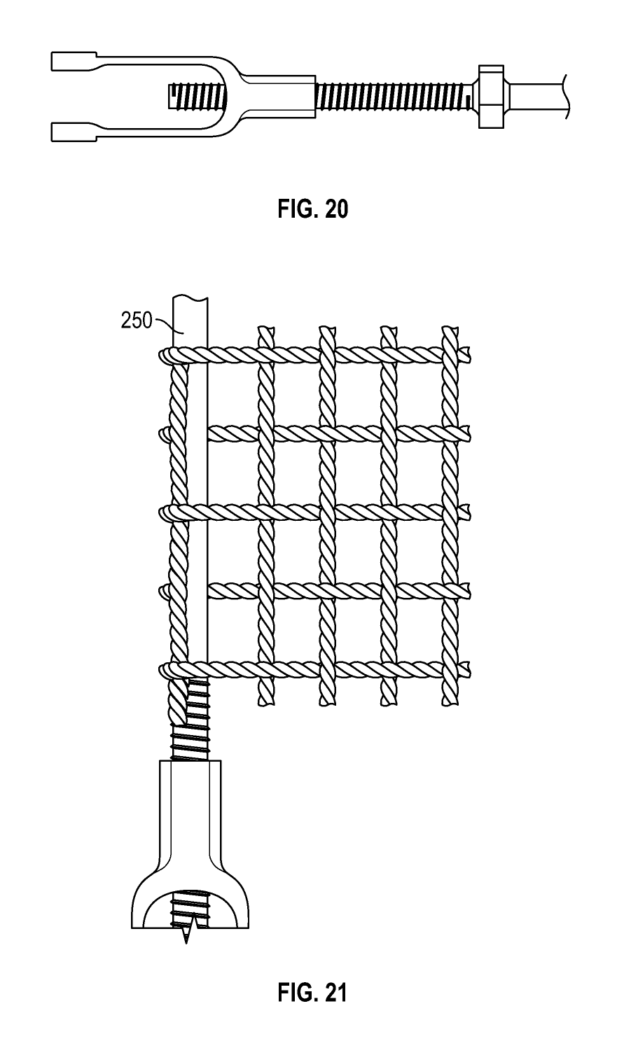

With respect to FIG. 19, there is shown an exemplary embodiment of the rod member 250. The rod member has a first end 252 and a second end. In the exemplary embodiment of FIG. 19, both ends are threaded and identical. In other exemplary embodiments, other configurations are possible and within the spirit and scope of the invention.

The rod member 250 is provided with connecting ends as shown in FIG. 19. A first connecting and 254 defines a yoke end. A nut 256 is threaded over the end of the rod member 250 and then the yoke is threaded thereafter the nut is tightened against the yoke for secure connection as well as for releasable connection.

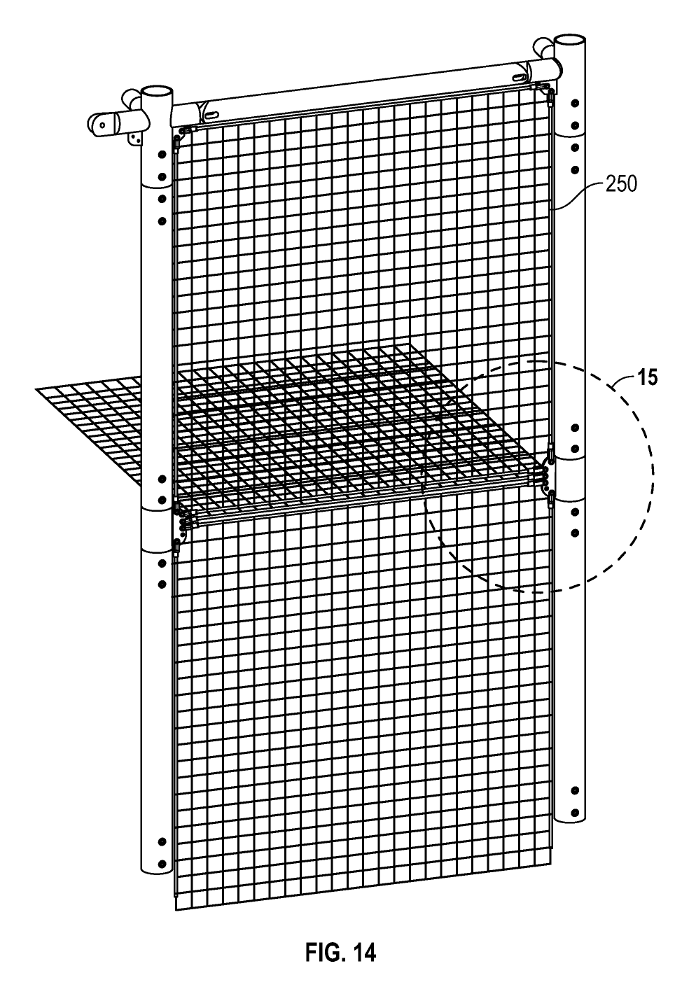

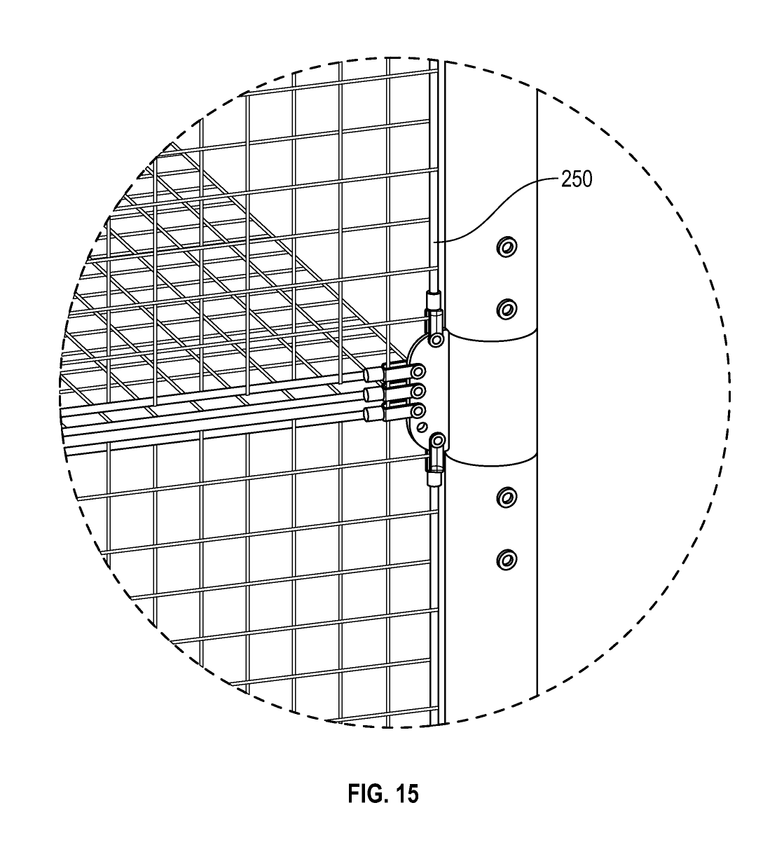

As shown in FIGS. 14 and 15, using the rod members 250, a stable modular play structure using netting is constructed. FIG. 21 illustrates the netting being interwoven to the rod member 250.

FIG. 22 is an exemplary example of the netting being lashed to the rod member 250. As will be appreciated, various type of connection between the rod members and the netting are possible and all are within the spirit and scope of the invention.

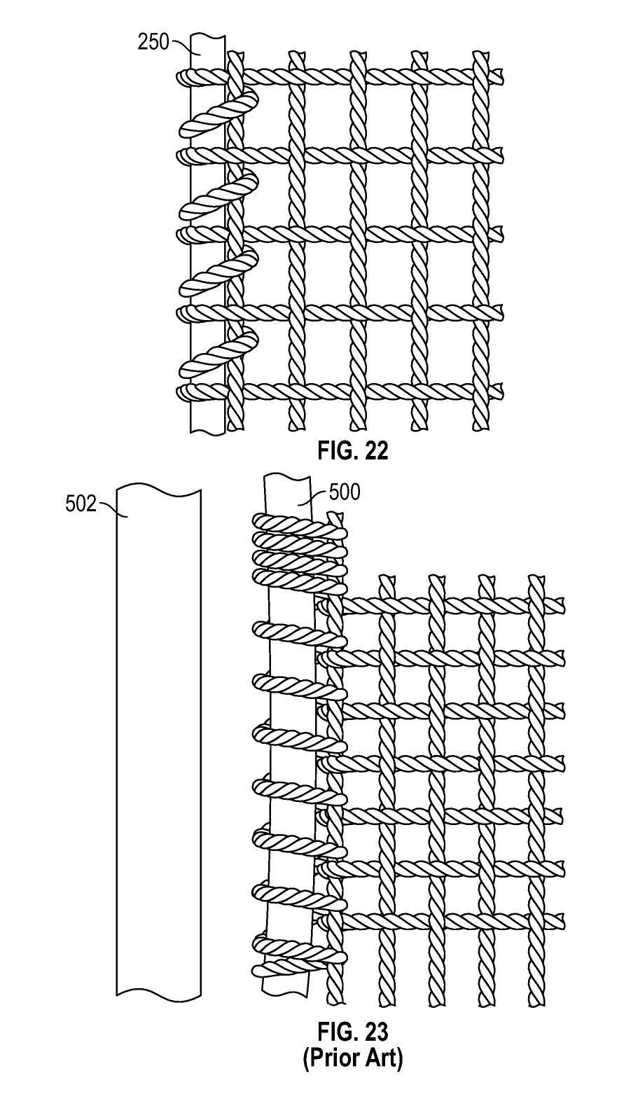

FIG. 23 is an example of the prior art where cables instead of rod members are employed. As shown, the cable 500 pulls away from the steel structural member 502 creating areas of structural anomalies that are ripe for injury for small feet, hands and legs of the participant of such play structures. While such structural anomalies like gaps occur using cables, they are clearly minimized while employing rod members 250.

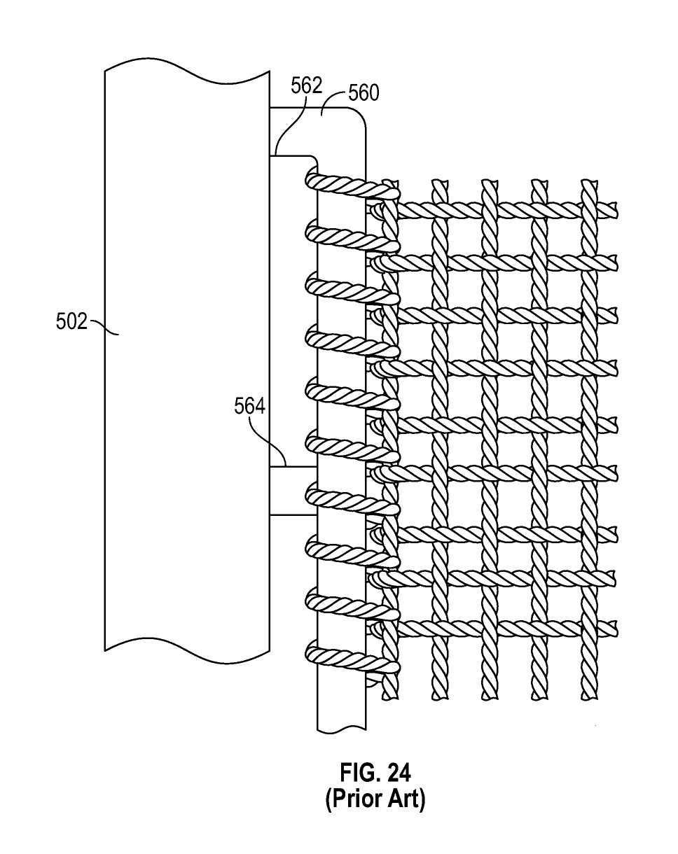

FIG. 24 is an example of the prior art where a support 560 is welded to the steel structural member 502. The support member 560 includes arms 562 and 564 which attach the support member 560 to the steel structural member 502 by welding. The length of the arms 562 and 564 inherently create a gap similar to the gap created by the prior art cable. The same safety concerns are present with this structure as well as the prior art cable structure.

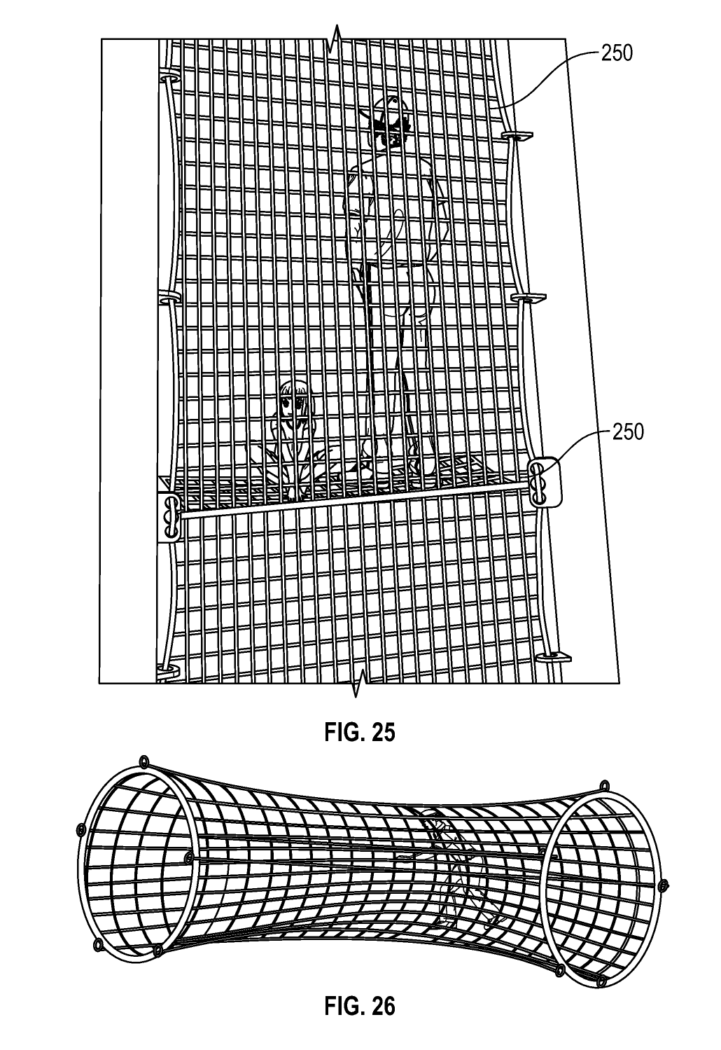

FIG. 25 illustrates a fully assembled portion of the modular play structure 100 using rod members as the supporting structure. As shown, the modular play structure 100 is under a load. Four young participants are shown provide the load on the netting. As shown, the horizontal rod member 250 is not suffering any deflection. Additionally, there are no structural anomalies, such as gaps as discussed above and below with regard to the cable play structure. Viewing the vertical rod member 250 clearly shows that no gaps are created despite the structural load.

On the other hand, FIG. 26 shows the structural anomalies of a cable modular play structure 100. The deflection from the horizon can be clearly seen as the cable responds to the load placed upon it by the participants.

1. A multi-piece connector for facilitating the construction of a modular amusement play structure, the multi-piece connector comprising:
a. a first tubular connection member comprising a first end, and an inner surface, the first end adapted for abutting connection;
b. a second tubular connection member comprising a first end, and an inner surface, the first end adapted for abutting connection with the first tubular connection member; and
c. a cylindrical inner connection member adapted to fit within the first and second pieces,
1. the inner connection member configured to outwardly expand and apply a uniform force to the inner surfaces of the first and second tubular connection members; and
2. releasable locking members interconnecting with the inner connection member adapted for expanding or contracting the inner connection member for locking the first and second tubular connection members together when their first ends are in abutment.

2. A multi-piece connector for facilitating the construction of a modular amusement play structure, the multi-piece connector comprising:
a. a first tubular connection member comprising a first end, and an inner surface, the first end adapted for abutting connection;
b. a second tubular connection member comprising a first end, and an inner surface, the first end adapted for abutting connection;
c. a tubular rod connection member comprising:
i. first and second ends configured to be rotatable between and abut the first ends of the first and second tubular connection members respectively; and
ii. an inner surface; and
d. a cylindrical inner connection member adapted to fit within the first and second tubular connection members and the tubular rod connection member,
i. the inner connection member configured to outwardly expand and apply a uniform force to the inner surfaces of the first and second tubular connection members and the tubular rod connection member; and
ii. releasable locking members interconnecting with the inner connection member adapted for expanding or contracting the inner connection member.
iii.

3. The multi-piece connector as set forth in claim 2, wherein the rod connection member further comprises at least one outwardly extending flange.

4. The multi-piece connector as set forth in claim 3, wherein the outwardly extending flange has at least one opening defining a rod connection point.

5. (canceled)

6. The multi-piece connector as set forth in claim 2, wherein the rod connection member further comprises a plurality of flanges that extend outwardly from the surface of the inner connection member.

7. (canceled)

8. The multi-piece connector as set forth in claim 6, wherein the plurality of outwardly extending flanges define opposing ears.

9. The multi-piece connector as set forth in claim 6, wherein the plurality of outwardly extending flanges define staggered ears.

10. The multi-piece connector as set forth in claim 6, wherein the plurality of outwardly extending flanges define ears that are staggered and opposed.

11. The multi-piece connector as set forth in claim 2, wherein the rod connection member further comprises multiple members and each of the members includes an outwardly extending flange having at least one opening for connection to a rod.

12. A multi-piece connector for facilitating the construction of a modular amusement play structure, the multi-piece connector comprising:
a. a first tubular connection member comprising a first end, and an inner surface, the first end shaped for abutting connection;
b. a second tubular connection member having a first end, and an inner surface, the first end shaped for abutting connection;
c. a tubular rod connection member comprising:
i. first and second ends configured to be rotatable between and abut the first ends of the first and second tubular connection members respectively; and
ii. an inner surface;
d. a cylindrical inner connection member adapted to fit within the first and second tubular connection members and the tubular rod connection member,
i. the inner connection member configured to outwardly expand and apply a uniform force to the inner surfaces of the first and second connection members and the tubular rod connection member; and
ii. releasable locking members interconnecting with the inner connection member adapted for expanding or contracting the inner connection member; and
e. at least one rod member adapted for connection to the tubular rod connection member,
whereupon the first and second tubular connection members are brought into abutting connection with the rod connection member and the rod connection member being freely rotatable.

13. The multi-piece connector as set forth in claim 12, wherein the at least one rod member has first and second ends and at least one of the ends comprises a yoke end and the other end defines a locking nut.
